(19) United States
(12) Patent Application Publication
(10) Pub. No.: US 2014/0325339 A1
(43) Pub. Date: Oct. 30, 2014

(54) METHOD, APPARATUS, AND MOBILE DEVICE FOR VIEWING PICTURES IN MOBILE PHONE BROWSER

(71) Applicant: Tencent Technology (Shenzhen) Company Limited, Shenzhen (CN)

(72) Inventors: Wenjun Gao, Shenzhen (CN); Ming He, Shenzhen (CN); Shi Zhen, Shenzhen (CN); Lei Chen, Shenzhen (CN)

(73) Assignee: Tencent Technology (Shenzhen) Company Limited, Shenzhen (CN)

(21) Appl. No.: 14/262,061

(22) Filed: Apr. 25, 2014

Related U.S. Application Data
(63) Continuation of application No. PCT/CN2012/080315, filed on Aug. 17, 2012.

(30) Foreign Application Priority Data
Oct. 27, 2011 (CN) 201110331359.3

(51) Int. Cl. G06F 17/22

(52) U.S. Cl. CPC G06F 17/2247
USPC 715/234

(57) ABSTRACT

Disclosed are a method, apparatus, and mobile device for viewing a picture in a mobile phone browser. The method for viewing a picture includes: invoking a picture viewing window to display a picture when a user performs an operation on a webpage for viewing the picture; caching all pictures and picture labels of all the pictures on the webpage; acquiring a screen-slide event, and acquiring a browser function corresponding to the screen-slide event according to the screen-slide event; and acquiring a new picture corresponding to the browser function according to the browser function and a picture label of the picture requested by the user for viewing, and switching the picture in the picture viewing window to the new picture. The apparatus includes an invoking and displaying module, a caching module, an acquiring module, and a switching module. The mobile device includes the apparatus.

This application is a continuation of International Patent Application No. PCT/CN2012/080315, filed on Aug. 17, 2012, which claims priority to Chinese Patent Application No. 201110331359.3, filed before Chinese Patent Office on Oct. 27, 2011 and entitled “METHOD, APPARATUS, AND MOBILE DEVICE FOR VIEWING PICTURES IN MOBILE PHONE BROWSER.” The disclosure of each of these prior applications is incorporated herein by reference in its entirety.

### TECHNICAL FIELD

The present disclosure relates to the field of computer technologies, and in particular, to a method, apparatus, and mobile device for viewing a picture in a mobile phone browser.

### BACKGROUND

With the development of communications, mobile phone operators start an era of full touchscreen mobile phones, and offer more possibilities for human-machine interaction implementation manners.

With a full touchscreen mobile phone, when opening a webpage to view a picture by using a browser, a user only needs to tap or press and hold the picture, and the browser invokes a picture viewing window for the user to view the picture. If the user desires to view a previous or next picture of the picture, the user needs to return from the current picture viewing window to the webpage where the picture is located, and then tap and view the previous or next picture of the picture.

During the implementation of the present disclosure, the inventor finds that the prior art has at least the following problems: In the prior art, when viewing a picture by using a picture viewing window, if a user desires to view a previous or next picture of the picture, the user needs to return from the current picture viewing window to a webpage where the picture is located, and then tap and view the previous or next picture of the picture. This slows down a speed for the user to view the picture and reduces service experience of the user. Moreover, an operation for saving a current picture during browsing is also complex.

### SUMMARY OF THE DISCLOSURE

In order to improve service experience when a user views a picture, embodiments of the present disclosure provide a method, apparatus, and mobile device for viewing a picture. The technical solutions are as follows:

A method for viewing a picture in a mobile phone browser includes:

invoking a picture viewing window to display a picture when a user performs an operation on a webpage for viewing the picture;

caching all pictures and picture labels of all the pictures on the webpage;

acquiring a screen-slide event, and acquiring a browser function corresponding to the screen-slide event according to the screen-slide event; and

acquiring a new picture corresponding to the browser function according to the browser function and a picture label of the picture requested by the user for viewing, and switching the picture in the picture viewing window to the new picture.

An apparatus for viewing a picture in a mobile phone browser includes:

an invoking and displaying module, configured to invoke a picture viewing window to display a picture when a user performs an operation on a webpage for viewing the picture;

a caching module, configured to cache all pictures and picture labels of all the pictures on the webpage;

an acquiring module, configured to acquire a screen-slide event, and acquire a browser function corresponding to the screen-slide event according to the screen-slide event; and

a switching module, configured to acquire a new picture corresponding to the browser function according to the browser function and a picture label of the picture requested by the user for viewing, and switch the picture in the picture viewing window to the new picture.

A mobile device includes the foregoing apparatus for viewing a picture.

The technical solutions provided in the embodiments of the present disclosure achieve the following beneficial effects: When a user opens a webpage by using a browser and views a picture by using a picture viewing window, if the user desires to view a previous or next picture of the picture, only a screen-slide operation is required to implement viewing the previous or next picture of the picture, which improves a speed and user service experience for the user to view the picture.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art can derive other accompanying drawings from these accompanying drawings without any creative efforts.

FIG. 1 is a flowchart of a method for viewing a picture according to an embodiment of the present disclosure;

FIG. 2 is a flowchart of a method for viewing a picture according to an embodiment of the present disclosure;

FIG. 3 is a flowchart of a method for viewing a picture according to an embodiment of the present disclosure;

FIG. 4 is a schematic diagram of an interface of a webpage having pictures according to an embodiment of the present disclosure;

FIG. 5 is a schematic diagram of a picture viewing window interface according to an embodiment of the present disclosure;

FIG. 6 is a schematic diagram of an apparatus for viewing a picture according to an embodiment of the present disclosure;

FIG. 7 is a first schematic diagram of an apparatus for viewing a picture according to an embodiment of the present disclosure;

FIG. 8 is a second schematic diagram of an apparatus for viewing a picture according to an embodiment of the present disclosure; and

FIG. 9 is a schematic diagram of a mobile device according to an embodiment of the present disclosure.

### DETAILED DESCRIPTION

Embodiments of the present disclosure provide a method, apparatus, and mobile device for viewing a picture.

To make the objectives, technical solutions, and advantages of the present disclosure clearer, the embodiments of the present disclosure are described in detail below with reference to the accompanying drawings.

### Embodiment 1

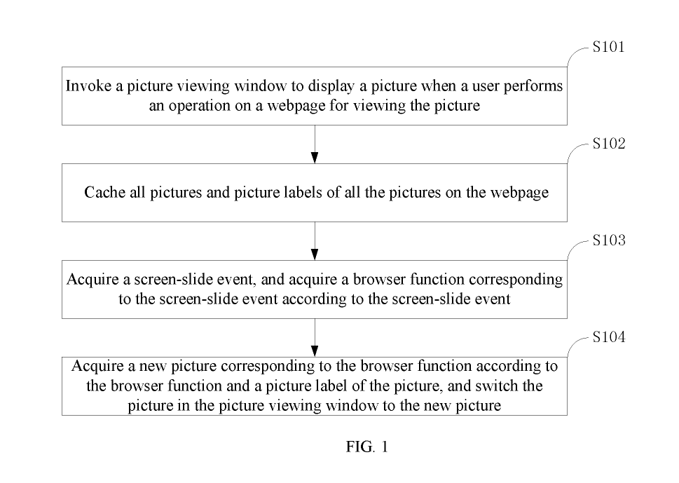

Referring to FIG. 1, FIG. 1 is a flowchart of a method for viewing a picture according to an embodiment of the present disclosure. The method for viewing a picture includes:

S101: invoking a picture viewing window to display a picture when a user performs an operation on a webpage for viewing the picture;

S102: caching all pictures and picture labels of all the pictures on the webpage;

S103: acquiring a screen-slide event, and acquiring a browser function corresponding to the screen-slide event according to the screen-slide event; and

S104: acquiring a new picture corresponding to the browser function according to the browser function and a picture label of the picture requested by the user for viewing, and switching the picture in the picture viewing window to the new picture.

In this embodiment, when a user opens a webpage by using a browser and views a picture by using a picture viewing window, if the user desires to view a previous or next picture of the picture, only a screen-slide operation is required to implement viewing the previous or next picture of the picture, which improves a speed and user service experience for the user to view the picture.

### Embodiment 2

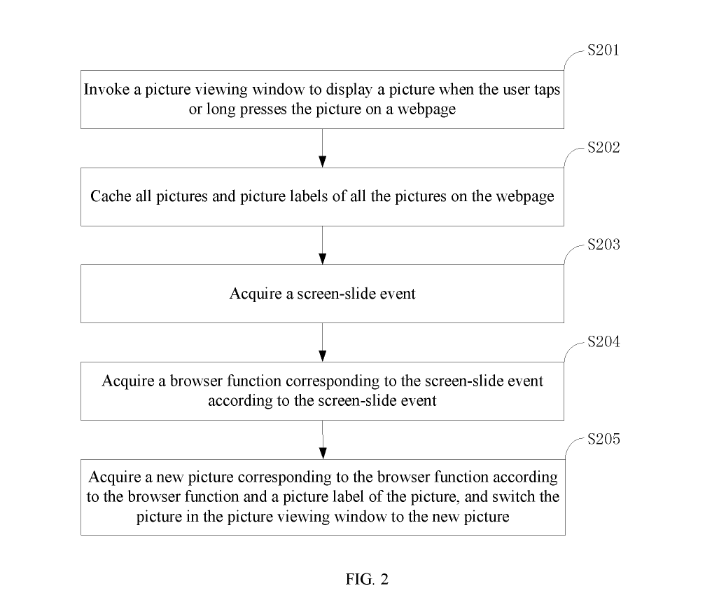

Referring to FIG. 2, FIG. 2 is a flowchart of a method for viewing a picture according to an embodiment of the present disclosure. An execution subject in this embodiment may be a mobile device, and specifically, may be a mobile phone, but is not limited thereto.

The method for viewing a picture includes:

S201: Invoking a picture viewing window to display a picture when a user taps or long presses the picture on a webpage.

In practice, when a user opens a webpage to view a picture by using a browser of a full touchscreen mobile phone, the user only needs to tap or long-press the picture to be viewed, and the browser invokes a picture viewing window to display the picture. Long pressing may also be understood as touching and holding.

S202: Caching all pictures and picture labels of all the pictures on the webpage.

If the webpage has a plurality of pictures, the browser caches all pictures on the webpage where the picture displayed in the picture viewing window is located, and caches picture labels of all the pictures. The picture labels of all the pictures one-to-one correspond to all the pictures. The picture label may be an image(img) picture label or a picture label of another type. The picture label according to this embodiment is not limited thereto.

The picture labels of all the pictures may be cached with an order in terms of positions of all the pictures on the webpage, or may be cached in another manner, which is not limited in this embodiment.

S203: Acquiring a screen-slide event.

When the user slides a screen on the touchscreen of the mobile phone, the browser acquires a screen-slide event, where the screen-slide event can be implemented by using a finger or implemented with another auxiliary tool. This embodiment is not limited thereto.

The screen-slide event includes left slide, right slide, up slide, and down slide. Up-left slide or up-right slide may belong to an up slide category; and similarly, down-left slide or down-right slide may belong to a down slide category. However, the categorization of up-left slide, up-right slide, down-left slide, and down-right slide is not limited thereto. Alternatively, up-left slide or up-right slide may belong to a left slide category; and down-left slide or down-right slide may belong to a right slide category.

S204: Acquiring a browser function corresponding to the screen-slide event according to the screen-slide event.

In practice, a mapping relationship between the screen-slide event and the browser function is preset. Specifically, when the screen-slide event is left slide or up slide, the browser function is switching to a previous picture; and when the screen-slide event is right slide or down slide, the browser function is switching to a next picture.

However, the mapping relationship between the screen-slide event and the browser function is not limited thereto, and may also be the following mapping relationship: when the screen-slide event is left slide or up slide, the browser function is switching to a next picture; and when the screen-slide event is right slide or down slide, the browser function is switching to a previous picture.

The acquiring a browser function corresponding to the screen-slide event according to the screen-slide event specifically includes: acquiring the browser function corresponding to the screen-slide event according to the screen-slide event and the preset mapping relationship between the screen-slide event and the browser function.

S205: Acquiring a new picture corresponding to the browser function according to the browser function and a picture label of the picture, and switching the picture in the picture viewing window to the new picture.

In practice, this step specifically includes searching, when the browser function is switching to a previous picture, for a picture label corresponding to the previous picture of the picture according to the browser function and the picture label of the picture; acquiring the previous picture of the picture according to the picture label corresponding to the previous picture; and switching the picture in the picture viewing window to the previous picture of the picture;

or

searching, when the browser function is switching to a next picture, for a picture label corresponding to a next picture of the picture according to the browser function and the picture label of the picture; acquiring the next picture of the picture according to the picture label corresponding to the next picture; and switching the picture in the picture viewing window to the next picture of the picture.

The searching, according to the browser function and the picture label of the picture, for a picture label corresponding to a previous picture of the picturespecifically includes:

if the picture labels of all the pictures are cached in an order in terms of positions of all the pictures on the webpage, directly acquiring a picture label at a position immediately preceding the picture label of the picture as the picture label of the previous picture of the picture; and if the picture labels of all the pictures are image (img) picture labels, searching, according to a picture address in the img picture label, for the picture label corresponding to the previous picture of the picture.

Similarly, a picture label corresponding to a next picture of the picture may also be searched for according to the above method.

In this embodiment, after the invoking the picture viewing window to display the picture in S201, the method for viewing a picture further includes:

scaling up or scaling down the picture in the picture viewing window.

In practice, after the browser invokes the picture viewing window to display the picture, an operation for scaling up or scaling down the picture may be performed with two fingers, so as to make it easy for the user to view the picture.

Before the switching the picture in the picture viewing window in S204, the method further includes:

downloading the picture in the picture viewing window.

Before the picture in the picture viewing window is switched, a downloading operation may also be performed on the picture. The picture may be downloaded to a local album of the mobile device, or the picture may be downloaded to another local position of the mobile device, where no specific limitation is set herein.

In this embodiment, when a user opens a webpage by using a browser and views a picture by using a picture viewing window, if the user desires to view a previous or next picture of the picture, only a screen-slide operation is required to implement viewing the previous or next picture of the picture, which improves a speed and user service experience for the user to view the picture.

The user may also perform an operation such as scale-up, scale-down, or download on the picture, such that the function for the user to perform an operation on the picture is enhanced, and user's service experience is also improved.

Moreover, a download button is provided in the picture viewing window in a viewing process, which makes it easy for the user to save a favorite picture quickly and conveniently. The download button may be provided, for example, in a lower part of the picture viewing window, and may be classified into download buttons of “Download to Local Memory”, “Download to Album”, and the like.

In order to make the embodiments of the present disclosure more comprehensible, the following provides further description by using an example of a scenario where the method according to the embodiment of the present disclosure is applicable to a QQ browser.

### Embodiment 3

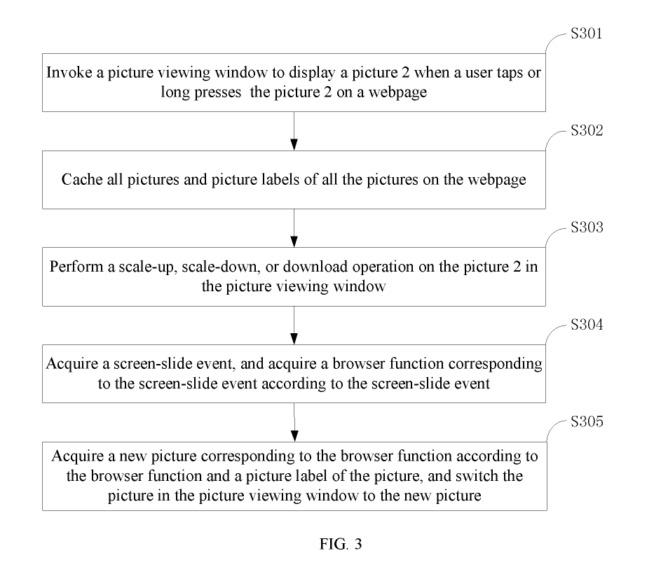

Referring to FIG. 3, FIG. 3 is a flowchart of a method for viewing a picture according to an embodiment of the present disclosure. An executing entity in this embodiment may be a mobile device, and specifically, may be a mobile phone, but is not limited thereto.

The method for viewing a picture includes:

S301: Invoking a picture viewing window to display a picture 2 when a user taps or long presses the picture 2 on a webpage.

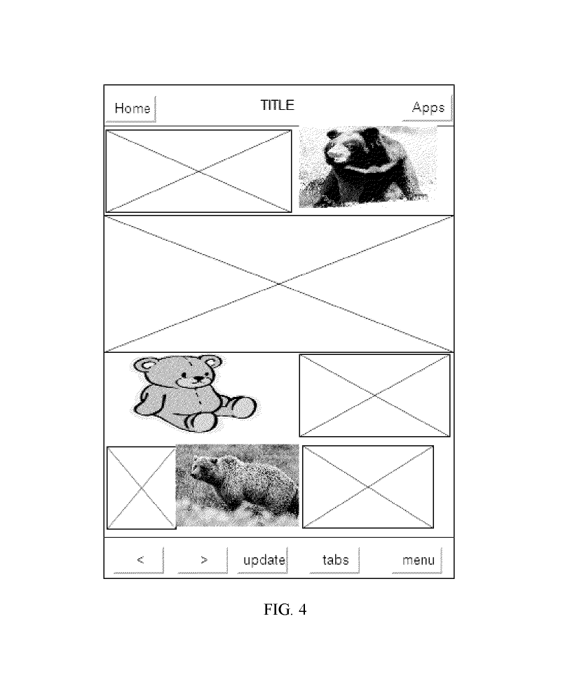

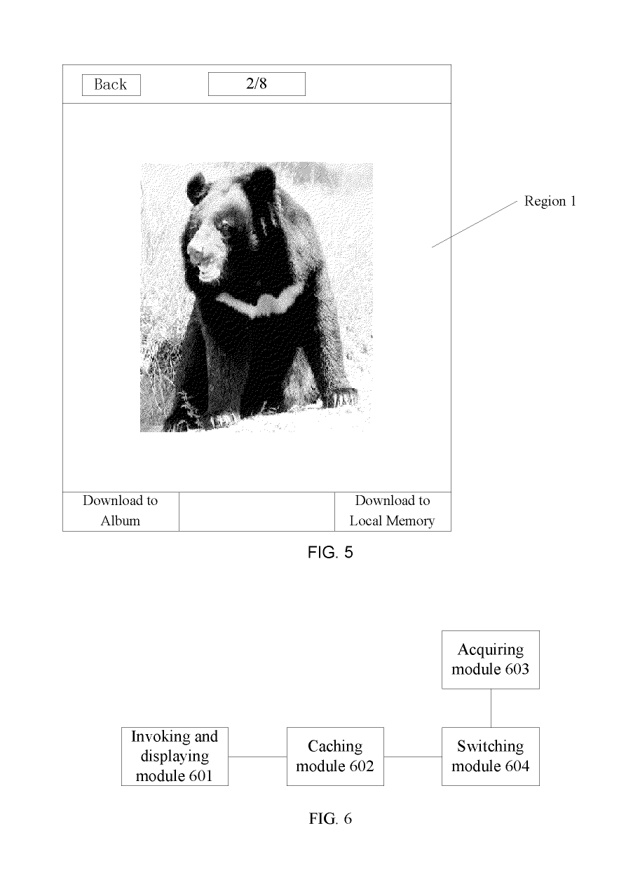

When a user opens a webpage to view a picture by using a QQ browser of a full touchscreen mobile phone, as shown in FIG. 4, the user only needs to tap or long press the picture 2 to be viewed, and the browser invokes a picture viewing window to display the picture 2, as shown in FIG. 5.

In the picture viewing window illustrated in FIG. 5, a “Back” button on a top-left corner of the picture supports returning from the picture viewing window to the webpage where the picture 2 is located, that is, returning to the webpage illustrated in FIG. 4. In “ 2/8” above the picture, “8” indicates the number of all pictures on the webpage where the picture 2 is located, and “2” indicates that the picture 2 is a second picture in terms of position among the eight pages. A “Download to Album” button on a bottom-left corner of the picture supports downloading the picture 2 to a local album of the mobile device. A “Download to Local Memory” button on a bottom-right corner of the picture supports downloading the picture 2 to a local memory of the mobile device.

S302: Caching all pictures and a picture label of all the pictures on the webpage.

The QQ browser caches the eight pictures displayed in FIG. 4 and a picture label of each of the eight pictures, where the picture label may be an img picture label. The picture labels of the eight pictures one-to-one correspond to the eight pictures.

S303: Performing a scale-up, scale-down, or download operation on the picture 2 in the picture viewing window.

The user may slide the picture 2 with two fingers to implement the scaling up or scaling down operation of the QQ browser on the picture 2, which makes it easy for the user to view the picture 2.

The downloading operation of the QQ browser on the picture 2 may also be implemented according to a related indication button (for example, the Download to Album button or the Download to Local Memory button) in FIG. 5.

S304: Acquiring a screen-slide event, and acquire a browser function corresponding to the screen-slide event according to the screen-slide event.

When the user slides the screen within a region 1 of the picture viewing window illustrated in FIG. 5, the QQ browser acquires the screen-slide event. The screen-slide event may be implemented with a finger or be implemented with another auxiliary tool. This embodiment is not limited thereto.

The “Back” button, “ 2/8”, and the “Download to Album” button or “Download to Local Memory” button are located in a region outside the region 1 illustrated in FIG. 5.

The screen-slide event is similar to the screen-slide event described in the above-described embodiment, which is not described repeatedly herein. For details, reference may be made to the related description in the above-described embodiment.

In practice, the acquiring a browser function corresponding to the screen-slide event according to the screen-slide event specifically includes that:

when the screen-slide event is left slide or up slide, the browser function corresponding to the screen-slide event is switching to a previous picture;

or

when the screen-slide event is right slide or down slide, the browser function corresponding to the screen-slide event is switching to a next picture.

S305: Acquiring a new picture corresponding to the browser function according to the browser function and a picture label of the picture, and switching the picture in the picture viewing window to the new picture.

In an actual application, this step specifically includes searching, when the browser function is switching to a previous picture, for a picture label corresponding to the previous picture of the picture according to the browser function and the picture label of the picture; acquiring the previous picture of the picture according to the picture label corresponding to the previous picture; and switching the picture in the picture viewing window to the previous picture of the picture;

or

searching, when the browser function is switching to a next picture, for a picture label corresponding to a next picture of the picture according to the browser function and the picture label of the picture; acquiring the next picture of the picture according to the picture label corresponding to the next picture; and switching the picture in the picture viewing window to the next picture of the picture.

The searching for a picture label corresponding to a previous picture of the picture according to the browser function and the picture label of the picture specifically includes:

if the picture label of all the pictures is cached in an order of the position of all the pictures on the webpage, directly acquiring a picture label at a position immediately preceding the picture label of the picture as the picture label of the previous picture of the picture; and if the picture label of all the pictures is an img picture label, searching for the picture label corresponding to the previous picture of the picture according to a picture address in the img picture label.

Similarly, a picture label corresponding to a next picture of the picture may also be searched for according to the above method.

In this embodiment, the picture 2 is the second picture among the eight pictures of the webpage illustrated in FIG. 4. When returning from the picture viewing window to the page illustrated in FIG. 4, a page position that is displayed is a page position where the picture label corresponding to the second picture is located, which makes it easily for the user to continue to browse the webpage.

In this embodiment, when a user opens a webpage to view a picture by using a browser, especially when browsing a webpage having many pictures, if the user desires to view a previous or next picture of the picture, only a screen-slide operation is required to implement viewing the previous or next picture of the picture, which improves a speed and user service experience for the user to view the picture.

Moreover, the user may also perform an operation such as scale-up, scale-down, or download on the picture, such that the function for the user to perform an operation on the picture is enhanced, and user's service experience is also improved. When the user returns to the page after viewing a picture by using the picture viewing window, a position for returning to the page is optimized, which makes it easily for the user to continue to browse the page.

### Embodiment 4

Referring to FIG. 6, FIG. 6 is a schematic diagram of an apparatus for viewing a picture according to an embodiment of the present disclosure. The apparatus for viewing a picture includes:

an invoking and displaying module 601, configured to invoke a picture viewing window to display a picture when a user performs an operation on a webpage for viewing the picture;

a caching module 602, configured to cache all pictures and a picture label of all the pictures on the webpage;

an acquiring module 603, configured to acquire a screen-slide event, and acquire a browser function corresponding to the screen-slide event according to the screen-slide event; and

a switching module 604, configured to acquire a new picture corresponding to the browser function according to the browser function and a picture label of the picture requested by the user for viewing, and switch the picture in the picture viewing window to the new picture.

In this embodiment, when a user opens a webpage by using a browser and views a picture by using a picture viewing window, if the user desires to view a previous or next picture of the picture, only a screen-slide operation is required to implement viewing the previous or next picture of the picture, which improves a speed and user service experience for the user to view the picture.

### Embodiment 5

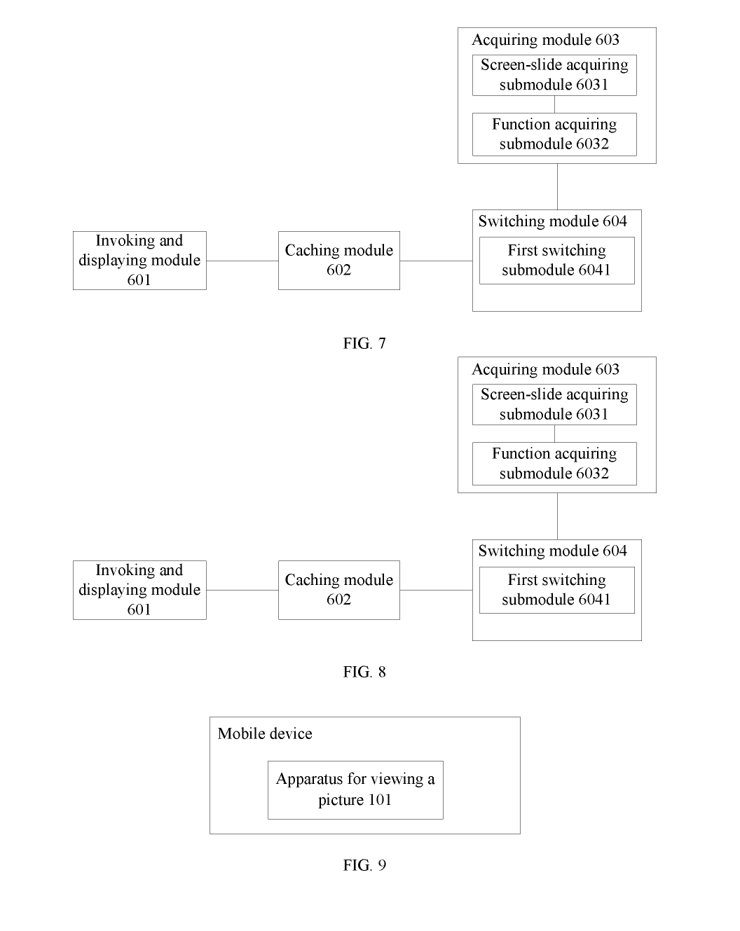

Referring to FIG. 7, FIG. 7 is a first schematic diagram of an apparatus for viewing a picture according to an embodiment of the present disclosure. The apparatus for viewing a picture includes: an invoking and displaying module 601, a caching module 602, an acquiring module 603, and a switching module 604, where the invoking and displaying module 601 and the caching module 602 are similar to the invoking and displaying module 601 and the caching module 602 in the above-described embodiment, which are not described repeatedly herein. For the details, reference may be made to the related description of the above-described embodiment.

The apparatus for viewing a picture in this embodiment may be a mobile device, and specifically, may be a mobile phone, but is not limited thereto.

The acquiring module 603 includes:

a screen-slide acquiring submodule 6031, configured to acquire a screen-slide event; and

a function acquiring submodule 6032, configured to acquire a browser function corresponding to the screen-slide event according to the screen-slide event.

The function acquiring submodule 6032 includes:

a first function acquiring unit, configured to acquire, when the screen-slide event is left slide or up slide, a browser function for switching to a previous picture corresponding to the screen-slide event;

or

a second function acquiring unit, configured to acquire, when the screen-slide event is right slide or down slide, a browser function for switching to a next picture corresponding to the screen-slide event.

The switching module 604 includes a first switching submodule 6041; or the switching module 604 includes a second switching submodule 6042, as shown in FIG. 8, where FIG. 8 is a second schematic diagram of the apparatus for viewing a picture according to an embodiment of the present disclosure.

The first switching submodule 6041 is configured to search, when the browser function is switching to a previous picture, for a picture label corresponding to the previous picture of the picture according to the browser function and the picture label of the picture; acquire the previous picture of the picture according to the picture label corresponding to the previous picture; and switch the picture in the picture viewing window to the previous picture of the picture;

or

the second switching submodule 6042 is configured to search, when the browser function is switching to a next picture, for a picture label corresponding to the next picture of the picture according to the browser function and the picture label of the picture; acquire the next picture of the picture according to the picture label corresponding to the next picture; and switch the picture in the picture viewing window to the next picture of the picture.

Furthermore, the apparatus for viewing a picture includes: a processing module, configured to scale up or scale down the picture in the picture viewing window.

Furthermore, the apparatus for viewing a picture includes: a downloading module, configured to download the picture in the picture viewing window.

Specifically, the picture in the picture viewing window may be downloaded to a local memory of the mobile device.

In this embodiment, when a user opens a webpage by using a browser and views a picture by using a picture viewing window, if the user desires to view a previous or next picture of the picture, only a screen-slide operation is required to implement viewing the previous or next picture of the picture, which improves a speed and user service experience for the user to view the picture.

The user may also perform an operation such as scale-up, scale-down, or download on the picture, such that the function for the user to perform an operation on the picture is enhanced, and user's service experience is also improved.

### Embodiment 6

Referring to FIG. 9, FIG. 9 is a schematic diagram of a mobile device according to an embodiment of the present disclosure. The mobile device includes an apparatus 101 for viewing a picture. The apparatus 101 for viewing a picture is similar to the apparatus for viewing a picture in the above-described embodiment, which is not described repeatedly herein. For details, reference may be made to the related description in the above-described embodiment.

In this embodiment, the mobile device may be a mobile phone, but is not limited thereto.

In this embodiment, when a user opens a webpage by using a browser and views a picture by using a picture viewing window, if the user desires to view a previous or next picture of the picture, only a screen-slide operation is required to implement viewing the previous or next picture of the picture, which improves a speed and user service experience for the user to view the picture.

The user may also perform an operation such as scale-up, scale-down, or download on the picture, such that the function for the user to perform an operation on the picture is enhanced, and user's service experience is also improved.

It should be noted that, the expression “a user performs an operation on a webpage for viewing the picture” mentioned in the specification is not limited to “tapping or long pressing”, and may also be another operation for viewing a picture, such as a common picture-viewing means of taping a picture-viewing button. This can be implemented by a person skilled in the art according to a common technical means thereof. Tapping or pressing and holding merely serve as a preferred embodiment therein. The protection scope of the present application is subject to the claims.

It should be noted that the embodiments in the specification are described in a progressive manner. Every embodiment illustrates in emphasis what is different from the other embodiments. The same or similar parts in the embodiments are just references to each other. For the apparatus embodiment, since it is basically similar to the method embodiment, the apparatus embodiment is described simply, and the relevant part may be acquired with reference to the part of the description of the method embodiment.

It should be noted that, as used herein, the terms “includes”, “comprises”, or any other variation thereof are intended to cover a non-exclusive inclusion, so that a process, method, article, or device that comprises a list of elements is not necessarily limited only to those elements, but may include other elements not expressly listed or inherent to such process, method, article, or device. An element defined by “at least one . . . ” does not, unless otherwise specified, preclude the existence of additional identical elements in the process, method, article, or device that includes the element.

A person skilled in the art should understand that all or part of steps of the preceding methods may be implemented by hardware or hardware following instructions of programs. The programs may be stored in a non-transitory computer-readable storage medium, and may be executed by at least one processor. The storage medium may be a read only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

1. A method for viewing a picture in a mobile phone browser, comprising:
invoking a picture viewing window to display a picture when a user performs an operation on a webpage for viewing the picture;
caching all pictures and picture labels of all the pictures on the webpage;
acquiring a screen-slide event, and acquiring a browser function corresponding to the screen-slide event according to the screen-slide event; and
acquiring a new picture corresponding to the browser function according to the browser function and a picture label of the picture requested by the user for viewing, and switching the picture in the picture viewing window to the new picture.

2. The method according to claim 1, wherein the invoking a picture viewing window to display a picture when a user performs an operation on a webpage for viewing the picture comprises:
invoking the picture viewing window to display the picture when the user taps or long presses the picture on the webpage.

3. The method according to claim 1, wherein the acquiring a browser function corresponding to the screen-slide event according to the screen-slide event comprises:
acquiring, when the screen-slide event is left slide or up slide, a browser function for switching to a previous picture corresponding to the screen-slide event;
or
acquiring, when the screen-slide event is right slide or down slide, a browser function for switching to a next picture corresponding to the screen-slide event.

4. The method according to claim 3, wherein the acquiring a new picture corresponding to the browser function according to the browser function and a picture label of the picture requested by the user for viewing comprises:
when the browser function is switching to the previous picture, searching for a picture label corresponding to the previous picture of the picture according to the browser function and the picture label of the picture requested by the user for viewing; and acquiring the previous picture of the picture according to the picture label corresponding to the previous picture; and
correspondingly, the switching the picture in the picture viewing window to the new picture specifically comprises:
switching the picture in the picture viewing window to the previous picture of the picture;
or
when the browser function is switching to the next picture, searching for a picture label corresponding to the next picture of the picture according to the browser function and the picture label of the picture requested by the user for viewing; and acquiring the next picture of the picture according to the picture label corresponding to the next picture; and
correspondingly, the switching the picture in the picture viewing window to the new picture specifically comprises:
switching the picture in the picture viewing window to the next picture of the picture;

5. The method according to claim 1, wherein after the invoking the picture viewing window to display the picture, the method further comprises:
scaling up or scaling down the picture in the picture viewing window.

6. The method according to claim 1, wherein before the switching the picture in the picture viewing window to the new picture, the method further comprises:
downloading the picture in the picture viewing window.

7. An apparatus for viewing a picture in a mobile phone browser, comprising:
an invoking and displaying module, configured to invoke a picture viewing window to display a picture when a user performs an operation on a webpage for viewing the picture;
a caching module, configured to cache all pictures and picture labels of all the pictures on the webpage;
an acquiring module, configured to acquire a screen-slide event, and acquire a browser function corresponding to the screen-slide event according to the screen-slide event; and
a switching module, configured to acquire a new picture corresponding to the browser function according to the browser function and a picture label of the picture requested by the user for viewing, and switch the picture in the picture viewing window to the new picture.

8. The apparatus according to claim 7, wherein the invoking and displaying module is configured to invoke the picture viewing window to display the picture when the user taps or long presses the picture on the webpage.

9. The apparatus according to claim 7, wherein the acquiring module comprises:
a screen-slide acquiring submodule, configured to acquire a screen-slide event; and
a function acquiring submodule, configured to acquire a browser function corresponding to the screen-slide event according to the screen-slide event.

10. The apparatus according to claim 9, wherein the function acquiring submodule comprises:
a first function acquiring unit, configured to acquire, when the screen-slide event is left slide or up slide, a browser function for switching to a previous picture corresponding to the screen-slide event;
or
a second function acquiring unit, configured to acquire, when the screen-slide event is right slide or down slide, a browser function for switching to a next picture corresponding to the screen-slide event.

11. The apparatus according to claim 10, wherein the switching module comprises:
a first switching submodule, configured to search, when the browser function is switching to a previous picture, for a picture label corresponding to the previous picture of the picture according to the browser function and the picture label of the picture requested by the user for viewing; acquire the previous picture of the picture according to the picture label corresponding to the previous picture; and switch the picture in the picture viewing window to the previous picture of the picture;
or
a second switching submodule, configured to search, when the browser function is switching to a next picture, for a picture label corresponding to the next picture of the picture according to the browser function and the picture label of the picture requested by the user for viewing; acquire the next picture of the picture according to the picture label corresponding to the next picture; and switch the picture in the picture viewing window to the next picture of the picture.

12. The apparatus according to claim 7, further comprising:
a processing module, configured to scale up or scale down the picture in the picture viewing window.

13. The apparatus according to claim 7, further comprising:
a downloading module, configured to download the picture in the picture viewing window.

14. A mobile device, comprising an apparatus for viewing a picture according to claim 7.

15. The mobile device according to claim 14, wherein the invoking and displaying module is configured to invoke the picture viewing window to display the picture when the user taps or long presses the picture on the webpage.

16. The mobile device according to claim 14, wherein the acquiring module comprises:
a screen-slide acquiring submodule, configured to acquire a screen-slide event; and
a function acquiring submodule, configured to acquire a browser function corresponding to the screen-slide event according to the screen-slide event.

17. The mobile device according to claim 16, wherein the function acquiring submodule comprises:
a first function acquiring unit, configured to acquire, when the screen-slide event is left slide or up slide, a browser function for switching to a previous picture corresponding to the screen-slide event;
or
a second function acquiring unit, configured to acquire, when the screen-slide event is right slide or down slide, a browser function for switching to a next picture corresponding to the screen-slide event.

18. The mobile device according to claim 17, wherein the switching module comprises:
a first switching submodule, configured to search, when the browser function is switching to a previous picture, for a picture label corresponding to the previous picture of the picture according to the browser function and the picture label of the picture requested by the user for viewing; acquire the previous picture of the picture according to the picture label corresponding to the previous picture; and switch the picture in the picture viewing window to the previous picture of the picture;
or
a second switching submodule, configured to search, when the browser function is switching to a next picture, for a picture label corresponding to the next picture of the picture according to the browser function and the picture label of the picture requested by the user for viewing; acquire the next picture of the picture according to the picture label corresponding to the next picture; and switch the picture in the picture viewing window to the next picture of the picture.

19. The apparatus according to claim 14, further comprising:
a processing module, configured to scale up or scale down the picture in the picture viewing window.

20. The apparatus according to claim 14, further comprising:
a downloading module, configured to download the picture in the picture viewing window.
